(19) United States
(12) Patent Application Publication
(10) Pub. No.: US 2021/0349184 A1
(43) Pub. Date: Nov. 11, 2021

(54) DISTANCE MEASURING DEVICE

(71) Applicant: DENSO CORPORATION, Kariya-city (JP)

(72) Inventor: Hidekazu ADACHI, Kariya-city (JP)

(21) Appl. No.: 17/379,636

(22) Filed: Jul. 19, 2021

Related U.S. Application Data
(63) Continuation of application No. PCT/JP2020/001567, filed on Jan. 17, 2020.

(30) Foreign Application Priority Data
Jan. 21, 2019 (JP) 2019-007641

(51) Int. Cl. G01S 7/486; G01S 17/10; G01S 7/481; G01S 17/931

(52) U.S. Cl. CPC G01S 7/486; G01S 17/931; G01S 7/4814; G01S 17/10

(57) ABSTRACT

A detection unit is configured to perform a top detection process in which a maximum value of intensity of a detection signal is stored, and when the intensity of the detection signal is reduced from the stored maximum value to a value that is smaller by a predetermined top determination value, a point of the detection signal that indicates the stored maximum value is determined as a top of a crest of a waveform of the detection signal. Furthermore, the detection unit is configured to perform a bottom detection process in which after the top of the crest is detected, a minimum value of the intensity of the detection signal is stored, and when the intensity of the detection signal is increased from the stored minimum value to a value that is larger by a predetermined bottom determination value, a point of the detection signal that indicates the stored minimum value is determined as a bottom of a trough of the waveform of the detection signal.

### CROSS-REFERENCE TO RELATED APPLICATION

This application is the U.S. bypass application of International Application No. PCT/JP2020/1567 filed on Jan. 17, 2020 which designated the U.S. and claims priority to Japanese Patent Application No. 2019-7641 filed on Jan. 21, 2019, the contents of both of which are incorporated herein by reference.

### TECHNICAL FIELD

The present disclosure relates to a distance measuring device that measures a distance to an object.

### BACKGROUND

One type of distance measuring devices that is mounted on a vehicle and measure a distance to an object located in front of the vehicle is a distance measuring device that emits a transmitting wave toward the front and detects a reflected wave of the emitted transmitting wave reflected from an object to calculate a distance to the object.

### SUMMARY

An aspect of the present disclosure is a distance measuring device that detects a reflected wave from an object and measures a distance to the object based on the reflected wave, and includes a signal output unit, a detection unit, a waveform dividing unit, and a distance calculation unit. The signal output unit is configured to output a detection signal corresponding to intensity of the reflected wave. The detection unit is configured to monitor intensity of the detection signal outputted from the signal output unit and detect a top of a crest and a bottom of a trough of a waveform of the detection signal. Furthermore, the detection unit is configured to perform a top detection process in which a maximum value of the intensity of the detection signal is stored, and when the intensity of the detection signal is reduced from the stored maximum value to a value that is smaller by a predetermined top determination value, a point of the detection signal that indicates the stored maximum value is determined as the top of the crest of the waveform of the detection signal. Furthermore, the detection unit is configured to perform a bottom detection process in which after the top of the crest is detected, a minimum value of the intensity of the detection signal is stored, and when the intensity of the detection signal is increased from the stored minimum value to a value that is larger by a predetermined bottom determination value, a point of the detection signal that indicates the stored minimum value is determined as the bottom of the trough of the waveform of the detection signal. The waveform dividing unit is configured to divide, based on the bottom of the trough detected by the detection unit, the waveform of the detection signal for each peak waveform indicating that the reflected wave is received. The distance calculation unit is configured to calculate the distance to the object based on the peak waveform obtained by the waveform dividing unit.

### BRIEF DESCRIPTION OF THE DRAWINGS

The above features of the present disclosure will be made clearer by the following detailed description, given referring to the appended drawings. In the accompanying drawings:

FIG. 1 is a block diagram showing a configuration of a distance measuring device;

FIG. 2 shows an overview of a peak waveform detection process;

FIG. 3 is a flow chart of the peak waveform detection process;

FIG. 4 shows a method of calculating a peak half-width and a peak top position;

FIG. 5 shows a method of correcting a peak distance; and

FIG. 6 shows a method of acquiring a noise value.

### DETAILED DESCRIPTION OF THE PREFERRED EMBODIMENTS

When a region irradiated with a transmitting wave from a distance measuring device includes two objects that are located close to each other and arranged in a direction in which the transmitting wave is emitted, the distance measuring device may obtain a detection signal having a waveform in which two peak waveforms indicating that reflected waves are received from the objects are connected to each other. A distance to the object is usually calculated based on a position of a center of the peak waveform or the like. Thus, if a dividing point between the two peak waveforms cannot be detected and the two peak waveforms are determined as a single peak waveform, in some cases, the distance to the object cannot be appropriately calculated.

In a distance measuring device disclosed in JP 4697072 B, for example, when a difference in signal component between a single verification point to be verified and each of the point immediately preceding the verification point and the point immediately following the verification point in time satisfies a predetermined condition, the verification point is used as a dividing point to divide a waveform of the detection signal.

As a result of study, the inventor has found a problem in which in the distance measuring device disclosed in JP 4697072 B, peak waveforms are divided based on a difference between successive verification points; thus, when in waveforms that are supposed to be divided as two peak waveforms, portions of the waveforms between two peaks are connected to each other to form a very gently sloping line, a dividing point between the peak waveforms cannot be detected, resulting in lower distance measurement accuracy.

An object of the present disclosure is to provide a distance measuring device capable of appropriately detecting a dividing point between peak waveforms and achieving high distance measurement accuracy.

An aspect of the present disclosure is a distance measuring device that detects a reflected wave from an object and measures a distance to the object based on the reflected wave, and includes a signal output unit, a detection unit, a waveform dividing unit, and a distance calculation unit. The signal output unit is configured to output a detection signal corresponding to intensity of the reflected wave. The detection unit is configured to monitor intensity of the detection signal outputted from the signal output unit and detect a top of a crest and a bottom of a trough of a waveform of the detection signal. Furthermore, the detection unit is configured to perform a top detection process in which a maximum value of the intensity of the detection signal is stored, and when the intensity of the detection signal is reduced from the stored maximum value to a value that is smaller by a predetermined top determination value, a point of the detection signal that indicates the stored maximum value is determined as the top of the crest of the waveform of the detection signal. Furthermore, the detection unit is configured to perform a bottom detection process in which after the top of the crest is detected, a minimum value of the intensity of the detection signal is stored, and when the intensity of the detection signal is increased from the stored minimum value to a value that is larger by a predetermined bottom determination value, a point of the detection signal that indicates the stored minimum value is determined as the bottom of the trough of the waveform of the detection signal. The waveform dividing unit is configured to divide, based on the bottom of the trough detected by the detection unit, the waveform of the detection signal for each peak waveform indicating that the reflected wave is received. The distance calculation unit is configured to calculate the distance to the object based on the peak waveform obtained by the waveform dividing unit.

Such a configuration appropriately detects a dividing point between peak waveforms.

Exemplary embodiments of the present disclosure will be described below with reference to the drawings.

### 1. First Embodiment

### [1-1. Configuration]

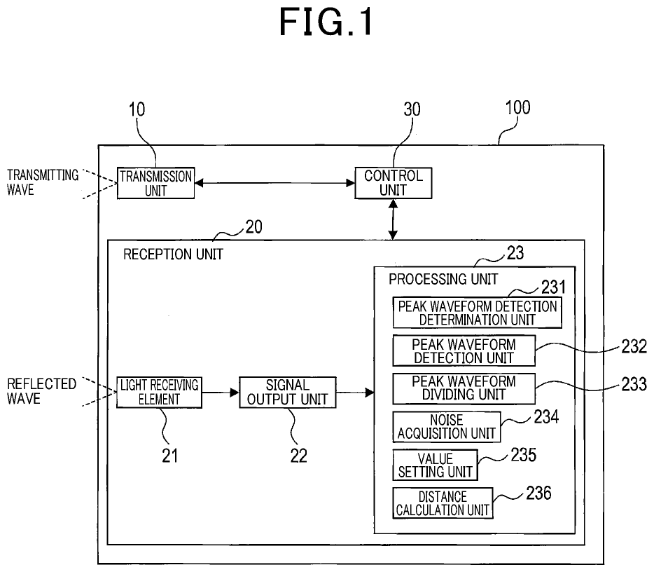

A lidar device 100 shown in FIG. 1 is a distance measuring device that emits light such as laser light as a transmitting wave and detects a reflected wave from an object irradiated with the light to measure a distance to the object. The term lidar is also written as LIDAR. LIDAR is an abbreviation for light detection and ranging. The lidar device 100 is mounted on a vehicle and used to detect various objects that are present in front of the vehicle.

The lidar device 100 includes a transmission unit 10, a reception unit 20, and a control unit 30.

The transmission unit 10 emits pulse laser light toward the front of the vehicle.

The reception unit 20 includes a light receiving element 21, a signal output unit 22, and a processing unit 23.

The light receiving element 21 receives a reflected wave of the emitted laser light, and outputs a light reception signal which is an electrical signal corresponding to intensity of the received reflected wave.

The signal output unit 22 converts the light reception signal outputted from the light receiving element 21 into a digital signal at a constant sampling frequency, and outputs the digital signal as a detection signal to the processing unit 23.

The processing unit 23 performs signal processing of the detection signal outputted from the signal output unit 22. Then, based on a result of the signal processing and a laser pulse output signal outputted from the control unit 30 to the transmission unit 10, the processing unit 23 calculates a distance to an object that has reflected laser light. In the present embodiment, the processing unit 23 is composed of hardware such as an FPGA (i.e., field-programmable gate array), and implements functions of a peak waveform detection determination unit 231, a peak waveform detection unit 232 (hereinafter also simply referred to as a “detection unit”), a peak waveform dividing unit 233, a noise acquisition unit 234, a value setting unit 235, and a distance calculation unit 236.

The peak waveform detection determination unit 231 is configured to start detection of a peak waveform when intensity of the detection signal exceeds a predetermined detection threshold Th. Specifically, the peak waveform detection determination unit 231 is configured to instruct the peak waveform detection unit 232 to start a top detection process (described later), when the intensity of the detection signal exceeds the detection threshold Th.

The peak waveform detection unit 232 is configured to monitor the intensity of the detection signal and detect a top of a crest and a bottom of a trough of a waveform of the detection signal. Specifically, the peak waveform detection unit 232 is configured to perform the top detection process for detecting the top of the crest of the waveform of the detection signal and a bottom detection process for detecting the bottom of the trough of the waveform of the detection signal.

The peak waveform dividing unit 233 is configured to divide, based on a detection result obtained by the peak waveform detection unit 232, the waveform of the detection signal for each peak waveform indicating that a reflected wave from the object is received.

Hereinafter, the processes performed by the peak waveform detection determination unit 231, the peak waveform detection unit 232, and the peak waveform dividing unit 233 are collectively referred to as a peak waveform detection process. The peak waveform detection process will be described later in detail.

The noise acquisition unit 234 is configured to acquire a noise value that indicates variation in the intensity of the detection signal outside a reflected wave detection period. Based on the noise value acquired by the noise acquisition unit 234, the value setting unit 235 sets the detection threshold Th used by the peak waveform detection determination unit 231, and sets various determination values used by the peak waveform detection unit 232 in the peak waveform detection process. Hereinafter, the processes performed by the noise acquisition unit 234 and the value setting unit 235 are collectively referred to as a value setting process. The value setting process will be described later in detail.

The distance calculation unit 236 is configured to calculate the distance to the object based on the detection result obtained by the peak waveform detection unit 232. Hereinafter, the process performed by the distance calculation unit 236 is referred to as a distance calculation process. The distance calculation process will be described later in detail.

The control unit 30 includes a microcomputer including a CPU, a ROM, a RAM, and the like. The control unit 30 outputs a laser pulse output signal to the transmission unit 10 so that the transmission unit 10 irradiates a desired search region with laser light. Furthermore, the control unit 30 controls the reception unit 20 so that during a predetermined detection period, the reception unit 20 receives a reflected wave of the laser light with which the search region is irradiated.

### [1-2. Processes]

Next, the peak waveform detection process performed by the processing unit 23 will be described.

### [1-2-1. Peak Waveform Detection Process]

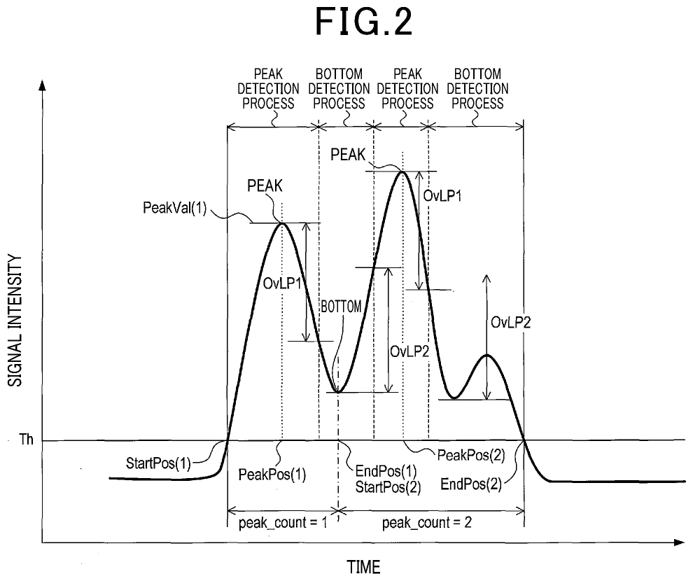

An overview of the peak waveform detection process performed by the processing unit 23 will be described with reference to FIG. 2.

The signal output unit 22 inputs a detection signal with a predetermined sampling period to the processing unit 23.

First, when an input value Input that indicates intensity of the detection signal exceeds the detection threshold Th, the processing unit 23 starts detection of a peak waveform.

Next, the processing unit 23 performs the top detection process to detect a top of a crest of a waveform of the detection signal and the bottom detection process to detect a bottom of a trough of the waveform of the detection signal.

Specifically, in the top detection process, the processing unit 23 stores a maximum value of the input value Input and updates the stored maximum value. Specifically, each time an input value Input (i) at a data number i is inputted, the input value Input (i) is compared with a stored maximum value (hereinafter referred to as a “stored maximum value max_peak”). When the input value Input (i) exceeds the stored maximum value max_peak, the stored maximum value max_peak is updated to the input value Input (i). Then, when the input value Input (i) is reduced from the stored maximum value max_peak to a value that is smaller by a predetermined top determination value OvLP1, a point of the detection signal that indicates the stored maximum value max_peak currently stored is determined as the top of the crest of the waveform of the detection signal.

When the top of the crest is detected in the top detection process, the processing unit 23 ends the top detection process and performs the bottom detection process.

In the bottom detection process, the processing unit 23 stores a minimum value of the input value Input and updates the stored minimum value. Specifically, each time an input value Input (i) at the data number i is inputted, the input value Input (i) is compared with a stored minimum value (hereinafter referred to as a “stored minimum value min_peak”). When the input value Input (i) is smaller than the stored minimum value min_peak, the stored minimum value min_peak is updated to the input value Input (i). Then, when the input value Input (i) is increased from the stored minimum value min_peak to a value that is larger by a predetermined bottom determination value OvLP2, a point of the detection signal that indicates the stored minimum value min_peak currently stored is determined as the bottom of the trough of the waveform of the detection signal. Then, the processing unit 23 sets the determined bottom as a dividing point between the peak waveforms.

When the bottom of the trough is detected in the bottom detection process, the processing unit 23 ends the bottom detection process and performs the top detection process.

Thus, the processing unit 23 repeatedly performs the top detection process and the bottom detection process.

Then, when the input value Input becomes the detection threshold Th or less, the processing unit 23 ends detection of a peak waveform.

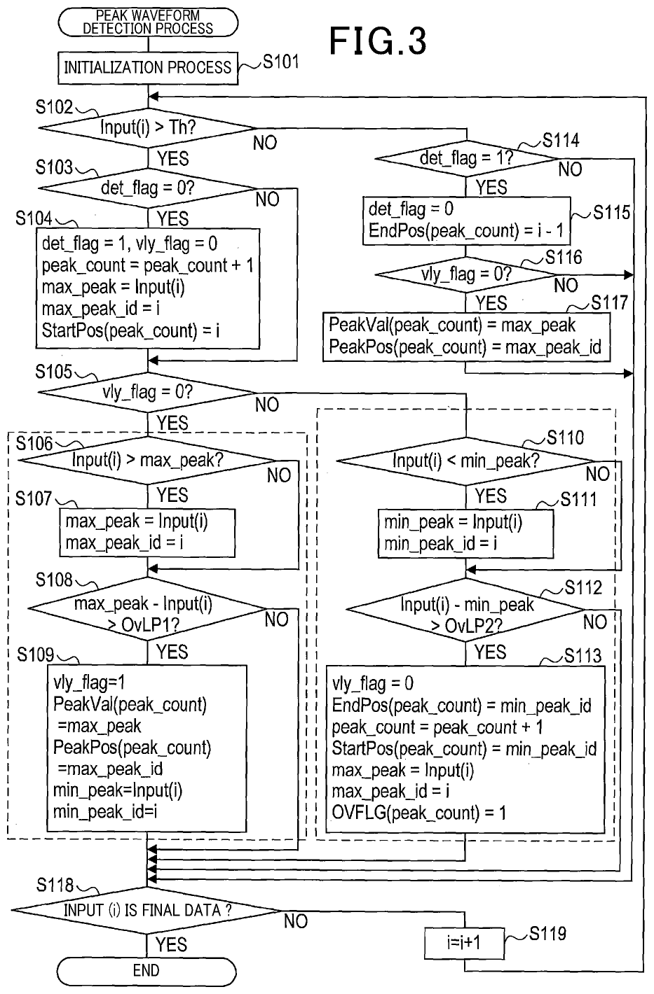

Next, the peak waveform detection process performed by the processing unit 23 will be described in detail with reference to a flow chart shown in FIG. 3. The peak waveform detection process shown in FIG. 3 is performed when a laser pulse output signal is outputted from the control unit 30 and laser light is emitted from the transmission unit 10, and then the detection period for the reception unit 20 is started.

First, at S101, the processing unit 23 performs an initialization process. Specifically, the processing unit 23 sets various parameters used in the peak waveform detection process, for example, a value such as a peak waveform count value peak_count (described later), to 0.

Subsequently, at S102, the processing unit 23 determines whether the input value Input (i) exceeds the detection threshold Th.

When the processing unit 23 determines at S102 that the input value Input (i) exceeds the detection threshold Th, control proceeds to S103, and the processing unit 23 determines whether a peak waveform detection flag det_flag is 0. The peak waveform detection flag det_flag is 1 when the previous input value Input (i−1) exceeds the detection threshold Th, and the peak waveform detection flag det_flag is 0 when the previous input value Input (i−1) is the detection threshold Th or less.

When the processing unit 23 determines at S103 that the peak waveform detection flag det_flag is 0, no detection of a peak waveform is performed at the input of the previous input value Input (i−1) and detection of a peak waveform is started at the input of the current input value Input (i); thus, control proceeds to S104, and the processing unit 23 sets the peak waveform detection flag det_flag to 1. Furthermore, at S104, the processing unit 23 sets initial values of various parameters used in the subsequent processes. Specifically, the processing unit 23 sets a bottom detection process flag vly_flag to 0, increases by 1 the peak waveform count value peak_count, sets the stored maximum value max_peak to the input value Input (i), sets a stored maximum value data position max_peak_id, which is a data position of the stored maximum value, to the data number i, and sets a peak waveform start position StartPos (peak_count), which is a start position of the peak waveform, to the data number i. Then, control proceeds to S105.

On the other hand, when the processing unit 23 determines at S103 that the peak waveform detection flag det_flag is not 0, S104 is skipped and control proceeds to S105.

At S105, the processing unit 23 determines whether the bottom detection process flag vly_flag is 0. The bottom detection process flag vly_flag is a flag indicating which of the top detection process at S106 to S109 (described later) and the bottom detection process at S110 to S113 (described later) is to be performed at the input of the current input value Input (i). The bottom detection process flag vly_flag is 1 when the bottom detection process is to be performed at the input of the current input value Input (i), and the bottom detection process flag vly_flag is 0 when the top detection process is to be performed at the input of the current input value Input (i).

When the processing unit 23 determines at S105 that the bottom detection process flag vly_flag is 0, control proceeds to S106, and the processing unit 23 determines whether the input value Input (i) exceeds the stored maximum value max_peak.

When the processing unit 23 determines at S106 that the input value Input (i) exceeds the current stored maximum value max_peak, in order to update the maximum value of the input value Input, control proceeds to S107, and the processing unit 23 sets the stored maximum value max_peak to the input value Input (i). Furthermore, at S107, the processing unit 23 sets the stored maximum value data position max_peak_id to the data number i. Then, control proceeds to S108.

On the other hand, when the processing unit 23 determines at S106 that the input value Input (i) does not exceed the stored maximum value max_peak, S107 is skipped and control proceeds to S108.

At S108, the processing unit 23 compares the stored maximum value max_peak with the input value Input (i), and determines whether a value obtained by subtracting the input value Input (i) from the stored maximum value max_peak exceeds the top determination value OvLP1.

When the processing unit 23 determines at S108 that the value obtained by subtracting the input value Input (i) from the stored maximum value max_peak exceeds the top determination value OvLP1, control proceeds to S109, and the processing unit 23 determines a crest peak data position PeakPos (peak_count), which is a data position of the top of the crest, and a crest top input value PeakVal (peak_count), which is an input value at the top of the crest. Specifically, the processing unit 23 sets the crest top input value PeakVal (peak_count) to the current stored maximum value max_peak, and sets the crest peak data position PeakPos (peak_count) to the current stored maximum value data position max_peak_id. Furthermore, at S109, the processing unit 23 also performs preparation for proceeding from the top detection process to the bottom detection process, that is, preparation for performing the bottom detection process at the input of the next input value Input (i+1). Specifically, the processing unit 23 sets the bottom detection process flag vly_flag to 1, sets the stored minimum value min_peak used in the bottom detection process to the Input (i) as an initial value, and sets a stored minimum value data position min_peak_id, which is a data position of the stored minimum value, to the data number i as an initial value. Then, control proceeds to S118.

On the other hand, when the processing unit 23 determines at S108 that the value obtained by subtracting the input value Input (i) from the stored maximum value max_peak does not exceed the top determination value OvLP1, S109 is skipped and control proceeds to S118.

On the other hand, when the processing unit 23 determines at S105 that the bottom detection process flag vly_flag is 1, control proceeds to S110, and the processing unit 23 determines whether the input value Input (i) is smaller than the stored minimum value min_peak.

When the processing unit 23 determines at S110 that the input value Input (i) is smaller than the current stored minimum value min_peak, in order to update the minimum value of the input value Input, control proceeds to S111, and the processing unit 23 sets the stored minimum value min_peak to the Input (i). Furthermore, at S111, the processing unit 23 sets the stored minimum value data position min_peak_id to the data number i.

On the other hand, when the processing unit 23 determines at S110 that the input value Input (i) is not smaller than the stored minimum value min_peak, S111 is skipped and control proceeds to S112.

At S112, the processing unit 23 compares the input value Input (i) with the stored minimum value min_peak, and determines whether a value obtained by subtracting the stored minimum value min_peak from the input value Input (i) exceeds the bottom determination value OvLP2.

When the processing unit 23 determines at S112 that the value obtained by subtracting the stored minimum value min_peak from the input value Input (i) exceeds the bottom determination value OvLP2, control proceeds to S113, and the processing unit 23 determines an end point of the peak waveform that serves as a dividing point between the peak waveforms. Specifically, the processing unit 23 sets a peak waveform end position EndPos (peak_count), which is an end position of the peak waveform, to the current stored minimum value data position min_peak_id. Furthermore, the processing unit 23 also performs preparation for proceeding from the bottom detection process to the top detection process, that is, preparation for performing the top detection process at the input of the next input value Input (i+1). Specifically, the processing unit 23 increases by 1 the peak waveform count value peak_count, sets the bottom detection process flag vly_flag to 0, sets the stored maximum value max_peak used in the top detection process to the input value input (i) as an initial value, sets the stored maximum value data position max_peak_id to the data number i, and sets the peak waveform start position StartPos (peak_count) to the stored minimum value data position min_peak_id. Furthermore, the processing unit 23 sets a trough detection flag OVFLAG (peak_count) used in the distance calculation process (described later) to 1. The trough detection flag OVFLAG (peak_count) is 1 when a trough is detected in a peak waveform having a desired count value peak_count, and the trough detection flag OVFLAG (peak_count) is 0 when no trough is detected in the peak waveform. Then, control proceeds to S118.

On the other hand, when the processing unit 23 determines at S112 that the value obtained by subtracting the stored minimum value min_peak from the input value Input (i) does not exceed the bottom determination value OvLP2, S113 is skipped and control proceeds to S118.

Returning to the description of S102, when the processing unit 23 determines at S102 that the input value Input (i) does not exceed the detection threshold Th, control proceeds to S114, and the processing unit 23 determines whether the peak waveform detection flag det_flag is 1.

When the processing unit 23 determines at S114 that the peak waveform detection flag det_flag is 1, the previous input value Input (i−1) exceeds the detection threshold Th and the current input value Input (i) becomes the detection threshold Th or less; thus, control proceeds to S115, and the processing unit 23 sets the peak waveform detection flag det_flag to 0. Furthermore, at S115, the processing unit 23 sets the peak waveform end position EndPos (peak_count) to the data number i−1 in order to determine the end point of the peak waveform detected so far. Then, control proceeds to S116.

On the other hand, when the processing unit 23 determines at S114 that the peak waveform detection flag det_flag is not 1, control proceeds to S118.

Subsequently, at S116, the processing unit 23 determines whether the bottom detection process flag vly_flag is 0.

When the processing unit 23 determines at S116 that the bottom detection process flag vly_flag is 0, there is a possibility that S109 is not performed and the top of the crest is not determined; thus, control proceeds to S117, and the processing unit 23 determines the top of the crest. Specifically, the processing unit 23 sets the crest top input value PeakVal (peak_count) to the stored maximum value max_peak, and sets the crest peak data position PeakPos (peak_count) to the stored maximum value data position max_peak_id. Then, control proceeds to S118.

On the other hand, when the processing unit 23 determines at S116 that the bottom detection process flag vly_flag is not 0, S117 is skipped and control proceeds to S118.

Subsequently, at S118, the processing unit 23 determines whether the input value Input (i) is final data. Specifically, the processing unit 23 determines whether the input value Input (i) is the last input value during the reflected wave detection period.

When the processing unit 23 determines at S118 that the input value Input (i) is not the final data, control proceeds to S119, and the processing unit 23 increases the data number i by 1, and then control returns to S102.

On the other hand, when the processing unit 23 determines at S118 that the input value Input (i) is the final data, the peak waveform detection process in FIG. 3 is ended.

### [1-2-2. Distance Calculation Process]

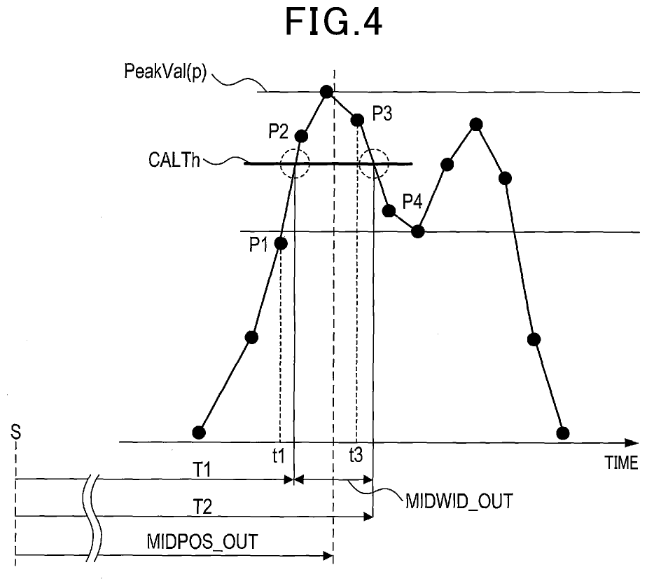

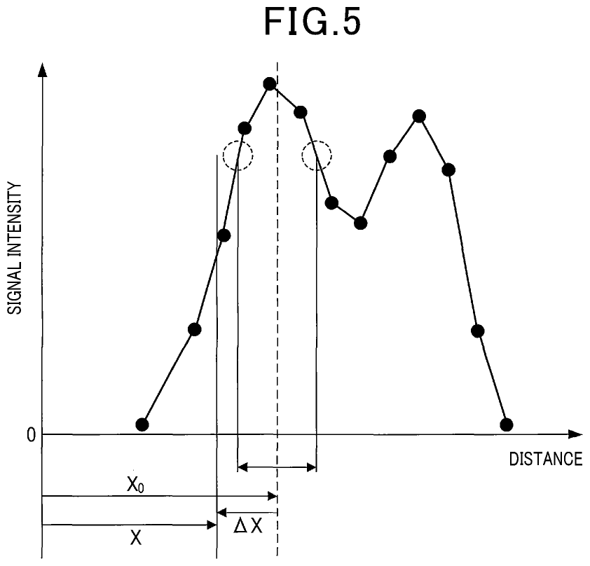

Next, the distance calculation process performed by the processing unit 23 as the distance calculation unit 236 will be described with reference to FIGS. 4 and 5.

First, the processing unit 23 obtains a peak calculation threshold CALTh as follows.

When in a waveform having a desired count value peak_count, the trough detection flag OVFLAG in the peak waveform detection process is 1, that is, when a trough is detected during the reflected wave detection period as shown in FIG. 4, the peak calculation threshold CALTh is obtained based on the following formula (1).

CALTh=(peak maximum value−trough value)×CALTh_RASIO+trough value (1)

The “peak maximum value” corresponds to a crest top input value PeakVal (p) of a peak waveform in which the count value peak_count=p in the peak waveform detection process. Furthermore, the “trough value” refers to a larger value between an input value at a peak waveform start position StartPos (p) of the peak waveform in which the count value peak_count=p and an input value at a peak waveform end position EndPos (p) of the peak waveform in which the count value peak_count=p. Furthermore, “CALTh_RASIO” is a constant that is set in advance, and satisfies 0<CALTh_RASIO<1.

On the other hand, when the trough detection flag OVFLAG is 0, that is, when no trough is detected during the reflected wave detection period, the peak calculation threshold CALTh is obtained based on the following formula (2).

CALTh=peak maximum value×CALTh_RASIO (2)

Next, as shown in FIG. 4, from data on the peak waveform in which the count value peak_count=p, points P1 to P4 that are located across the obtained peak calculation threshold CALTh are extracted. Then, a peak half-width MIDWID_OUT and a peak top position MIDPOS_OUT of the peak waveform in which the count value peak_count=p are calculated based on the following formulas (3) to (6).

$$\begin{matrix}\begin{matrix}T 1 = ( t 2 - t 1 ) \times ( CALTh - Input ( t 1 ) ) / ( Input ( t 2 ) - Input ( t 1 ) ) + t 1 \\ = ( CALTh - Input ( t 1 ) ) / ( Input ( t 2 ) - Input ( t 1 ) ) + t 1\end{matrix} & ( 3 ) \\ \begin{matrix}T 2 = ( t 4 - t 3 ) \times ( Input ( t 3 ) - CALTh ) / ( Input ( t 3 ) - Input ( t 4 ) ) + t 3 \\ = ( Input ( t 3 ) - CALTh ) / ( Input ( t 3 ) - Input ( t 4 ) ) + t 3\end{matrix} & ( 4 ) \\ MIDWID \# OUT = T 2 - T 1 & ( 5 ) \\ MIDPOS \# OUT = ( T 2 + T 1 ) / 2 & ( 6 )\end{matrix}$$

In the formulas (3) and (4), t1, t2, t3, and t4 are positions at the points P1, P2, P3, and P4 with respect to a start point S of the detection period. Furthermore, values between the positions of the data points are normalized; thus, t2−t1 in the formula (3) and t4−t3 in the formula (4) are 1.

The peak half-width MIDOWID_OUT and the peak top position MIDPOS_OUT obtained in this manner serve as object detection information.

Next, the obtained peak top position MIDPOS_OUT is converted from a value based on the time axis to a value based on the distance by using a time distance conversion coefficient based on the following formula (7).

Peak distance X₀=time distance conversion coefficient×MIDPOS_OUT (7)

Next, as shown in FIG. 5, the obtained peak distance X₀ is dependent on the peak width and is deviated from the actual distance to the object; thus, the peak distance is corrected as follows by using a pulse width distance correction amount ΔX. The pulse width distance correction amount ΔX is determined based on the peak half-width MIDWID_OUT.

Peak distance X=peak distance X₀−pulse width distance correction value ΔX

The peak distance X obtained in this manner is the distance to the object.

### [1-2-3. Value Setting Process]

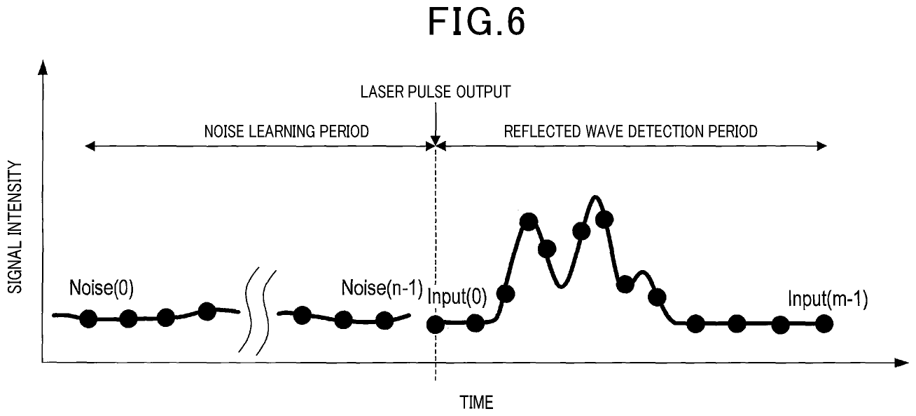

Next, the value setting process performed by the processing unit 23 as the value setting unit 235 will be described with reference to FIG. 6.

During a noise learning period that is set in advance outside the reflected wave detection period, the processing unit 23 acquires a noise value that indicates variation in the intensity of the detection signal. Then, the processing unit 23 sets the top determination value OvLP1, the bottom determination value OvLP2, and the detection threshold Th based on the noise value.

When the noise value greatly varies, for example, when a large noise component is superimposed on a waveform, a point that is not supposed to be detected as a dividing point between peak waveforms may be detected as a dividing point, or the noise component may be erroneously detected as a peak waveform. In order to prevent such erroneous division and erroneous detection, the processing unit 23 sets the top determination value OvLP1, the bottom determination value OvLP2, and the detection threshold Th according to the noise value.

Specifically, as shown in FIG. 6, during the noise learning period, the processing unit 23 acquires n input values Noise (t) (t=0 to n−1) of discrete detection signals, and obtains a standard deviation σ of the input values. The standard deviation σ is obtained based on the following formulas (8) to (10).

M=Σ(Noise(t)) (8)

μ=M/n (9)

σ=sqrt(Σ(Noise(t)−μ)²/n) (10)

The top determination value OvLP1 and the bottom determination value OvLP2 are set by using the standard deviation σ based on the following formula (11), and the detection threshold Th is set by using the standard deviation σ based on the following formula (12).

OvLP1=OvLP2=ko×σ (11)

Th=kd×σ (12)

Each of ko in the formula (11) and kd in the formula (12) is an arbitrary constant, and is a design value that is set in advance. The average μ calculated based on the formula (9) is used as a zero reference of the signal intensity of the reflected wave.

### [1-3. Effects]

The embodiment described above in detail achieves the following effects.

(1a) In the above configuration, when the intensity of the detection signal is reduced to a value smaller by the predetermined top determination value OvLP1 than the stored maximum value of the detection signal, the processing unit 23 determines, as the top of the crest, a point of the detection signal that indicates the maximum value. Furthermore, when after the top of the crest is detected, the intensity of the detection signal is increased from the stored minimum value of the detection signal to a value that is larger by the predetermined bottom determination value OvLP2, the processing unit 23 determines, as the bottom of the trough, a point of the detection signal that indicates the minimum value. Then, the processing unit 23 uses the detected bottom of the trough as a dividing point to divide the peak waveforms. That is, in the above configuration, the bottom of the trough serving as a dividing point between the peak waveforms is detected based on a difference between the verification point and the top of the crest and a difference between the verification point and the bottom of the trough.

According to such a configuration, for example, as compared with the case where a dividing point between the peak waveforms is detected based on a difference between verification points as with the distance measuring device described in JP 4697072 B mentioned above, even when portions of waveforms between two peaks are connected to each other to form a very gently sloping line, a dividing point between the two peak waveforms is appropriately detected.

(1b) Furthermore, in the method in which a dividing point between the peak waveforms is detected based on a difference between the verification points, peak waveform dividing performance greatly varies depending on a sampling period of the verification points. Thus, for example, if the sampling period is shortened to improve distance measurement accuracy, the difference between the points used to divide the peak waveforms is reduced, and this makes it difficult to detect a dividing point. Furthermore, the influence of a noise component on the difference between the points increases, and erroneous division due to noise is more likely to occur.

On the other hand, according to the above configuration, the top determination value OvLP1 and the bottom determination value OvLP2 that are used to detect a dividing point between the peak waveforms can be set to be larger than a difference used to detect a dividing point between the peak waveforms in detection of a dividing point based on a difference between the verification points. Thus, the above configuration allows a dividing point between the peak waveforms to be appropriately detected while preventing erroneous division due to noise.

(1c) In the above configuration, the processing unit 23 is configured to monitor the intensity of the detection signal outputted from the signal output unit 22 and detect the top of the crest and the bottom of the trough of the waveform of the detection signal. According to such a configuration, by simply scanning once detection signals that are successively inputted, it is possible to extract information on the top of the crest and the bottom of the trough that is required to calculate the distance to the object.

(1d) In the above configuration, the processing unit 23 repeatedly performs the top detection process and the bottom detection process. Thus, division of peak waveforms is appropriately performed not only for a waveform in which two peak waveforms are connected to each other but also for any number of superimposed waveforms.

(1e) In the above configuration, the top determination value OvLP1 and the bottom determination value OvLP2 that are used to divide the peak waveforms are set based on the noise value acquired by the noise acquisition unit 234; thus, erroneous division due to noise is prevented.

(1f) In the above embodiment, the peak waveform detection threshold is set based on the noise value acquired by the noise acquisition unit 234; thus, erroneous detection due to noise is prevented.

### 2. Other Embodiments

The embodiment of the present disclosure has been described above. However, needless to say, the present disclosure is not limited to the above embodiment and may be implemented in various forms.

(2a) In the above embodiment, the top determination value OvLP1 and the bottom determination value OvLP2 that is used in the bottom detection process are the same value, but the top determination value and the bottom determination value may be different values.

(2b) In the above embodiment, both the top determination value OvLP1 and the bottom determination value OvLP2 are set based on the noise value acquired by the noise acquisition unit 234, but only one of the top determination value OvLP1 and the bottom determination value OvLP2 may be set based on the noise value.

(2c) In the above embodiment, the peak maximum value obtained based on the half-width of the peak waveform is used to calculate the distance to the object, but the method of calculating the distance to the object is not limited to this. For example, the distance to the object may be calculated based on the start position of the peak waveform.

(2d) In the above embodiment, a point determined as the bottom of the trough serves as a dividing point between the peak waveforms, but the dividing point between the peak waveforms is not limited to this. Thus, the dividing point between the peak waveforms may be determined based on the bottom of the trough. Therefore, for example, the dividing point between the peak waveforms may be a point a certain period apart from the point determined as the bottom of the trough, for example, a point before or after the point determined as the bottom of the trough.

(2e) In the above embodiment, the lidar device is presented as an example of the distance measuring device, but the type of distance measuring device is not limited to this. Specifically, the distance measuring device may be, for example, a millimeter wave radar device or an ultrasonic sensor device.

(2f) In the above embodiment, the function of a single component may be divided into a plurality of components, or the functions of a plurality of components may be integrated into a single component. Furthermore, part of the configuration of the embodiment may be omitted. Furthermore, at least part of the configuration of the embodiment may be, for example, added to or replaced with another configuration of the embodiment.

(2g) Other than the above-described distance measuring device, the present disclosure may also be implemented in various forms such as a system including the above-described distance measuring device as a component, a program for functioning a computer as the processing unit 23, a medium on which the program is recorded, and a method of detecting a peak waveform.

What is claimed is:

1. A distance measuring device that detects a reflected wave from an object and measures a distance to the object based on the reflected wave, comprising:
a signal output unit configured to output a detection signal corresponding to intensity of the reflected wave;
a detection unit configured to monitor intensity of the detection signal outputted from the signal output unit and detect a top of a crest and a bottom of a trough of a waveform of the detection signal and configured to perform a top detection process and a bottom detection process, the top detection process being a process in which a maximum value of the intensity of the detection signal is stored, and when the intensity of the detection signal is reduced from the stored maximum value to a value that is smaller by a predetermined top determination value, a point of the detection signal that indicates the stored maximum value is determined as the top of the crest of the waveform of the detection signal, the bottom detection process being a process in which after the top of the crest is detected, a minimum value of the intensity of the detection signal is stored, and when the intensity of the detection signal is increased from the stored minimum value to a value that is larger by a predetermined bottom determination value, a point of the detection signal that indicates the stored minimum value is determined as the bottom of the trough of the waveform of the detection signal;
a waveform dividing unit configured to divide, based on the bottom of the trough detected by the detection unit, the waveform of the detection signal for each peak waveform indicating that the reflected wave is received; and
a distance calculation unit configured to calculate the distance to the object based on the peak waveform obtained by the waveform dividing unit.

2. The distance measuring device according to claim 1, wherein
the detection unit repeatedly performs the top detection process and the bottom detection process.

3. The distance measuring device according to claim 1, further comprising:
a noise acquisition unit configured to acquire a noise value that indicates variation in the intensity of the detection signal outside a reflected wave detection period; and
a value setting unit configured to set at least one of the top determination value and the bottom determination value based on the noise value.

4. The distance measuring device according to claim 1, further comprising:
a detection determination unit configured to determine whether to perform the top detection process by the detection unit, wherein
when the intensity of the detection signal outputted from the signal output unit exceeds a predetermined detection threshold, the detection determination unit determines to perform the top detection process by the detection unit.

5. The distance measuring device according to claim 3, further comprising:
a detection determination unit configured to determine whether to perform the top detection process by the detection unit, wherein:
when the intensity of the detection signal outputted from the signal output unit exceeds a predetermined detection threshold, the detection determination unit determines to perform the top detection process by the detection unit; and
the value setting unit further sets the detection threshold based on the noise value.
